(19) United States
(12) Patent Application Publication
(10) Pub. No.: US 2024/0383539 A1
(43) Pub. Date: Nov. 21, 2024

(54) AXLE SKID SHIELD COVER PAN

(71) Applicant: GM Global Technology Operations LLC, Detroit, MI (US)

(72) Inventors: Steven W. CREEK, Shelby Twp., MI (US); Michael Andrew Gutierrez, Dearborn Heights, MI (US); David Schankin, Harrison Twp., MI (US)

(21) Appl. No.: 18/319,764

(22) Filed: May 18, 2023

(51) Int. Cl. B62D 25/20

(52) U.S. Cl. CPC B62D 25/2072

(57) ABSTRACT

A skid shield cover for a differential housing includes a differential cover and a skid shield fixedly connected directly to the differential cover. The skid shield is configured to cover a bottom surface of the differential housing.

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

For the off-road vehicle market, underbody protection is highly desired to protect sensitive components from impact damage. The present disclosure relates to an axle skid shield cover pan.

### SUMMARY

Further areas of applicability of the present disclosure will become apparent from the detailed description, the claims and the drawings. The detailed description and specific examples are intended for purposes of illustration only and are not intended to limit the scope of the disclosure.

According to an aspect of the present disclosure, a skid shield cover for a differential housing includes a differential cover and a skid shield fixedly connected directly to the differential cover. The skid shield is configured to cover a bottom surface of the differential housing.

According to a further aspect, a mounting boss extends from the skid shield and is configured to be mounted to the differential housing.

According to a further aspect, the skid shield includes a debris exit hole.

According to a further aspect, the skid shield is configured to define a plurality of air inlets between the skid shield and the differential and the skid shield includes a plurality of air outlets.

According to a further aspect, a differential cover attachment boss extends from the differential cover, the differential cover attachment boss defines a differential cover attachment hole for attaching the skid shield to the differential housing.

According to a further aspect, the differential cover includes a mounting flange defining a plurality of attachment holes and a bowl member fixedly connected to the mounting flange.

According to a further aspect, the skid shield includes a bottom panel configured to extend from the differential cover to an input shaft flange of the differential housing, and configured to extend from a first axle flange to a second axle flange, a first sidewall panel extending from the bottom panel and configured to extend from the input shaft flange to the first axle flange and a second sidewall panel extending from the bottom panel and configured to extend from the input shaft flange to the second axle flange.

According to a further aspect, the skid shield is formed integral with the differential cover.

According to a further aspect, the skid shield is welded to the differential cover.

According to another aspect, a differential assembly includes a differential housing having an input shaft flange, a first axle flange and a second axle flange, and an open end with a first mounting flange having a plurality of attachment holes. An input shaft member extends from the input shaft flange of the differential housing. A first axle extends through the first axle shaft flange. A second axle extends through the second axle flange. A differential cover includes a second mounting flange connected to the first mounting flange of the differential housing. A skid shield is fixedly connected to the differential cover, the skid shield extending adjacent to a bottom of the differential housing. A plurality of bolts are inserted into corresponding attachment holes in the first mounting flange and the second mounting flange.

According to an aspect of the present disclosure, a method of attaching a skid shield to a differential housing includes forming a differential cover and a skid shield integrally form a single sheet of metal and mounting the differential cover to a differential housing.

### BRIEF DESCRIPTION OF THE DRAWINGS

The present disclosure will become more fully understood from the detailed description and the accompanying drawings, wherein:

FIG. 1 is a top rear perspective view of a differential for an off-road vehicle having a skid shield cover pan according to the principles of the present disclosure;

FIG. 2 is a rear perspective view of the skid shield cover pan according to the principles of the present disclosure; and

FIG. 3 is a front perspective view of the skid shield cover pan.

In the drawings, reference numbers may be reused to identify similar and/or identical elements.

### DETAILED DESCRIPTION

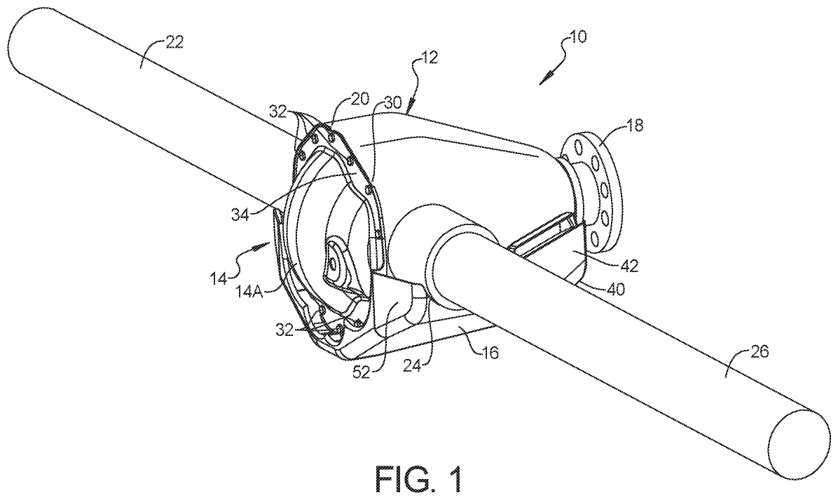

Referring to FIG. 1, an exemplary differential assembly 10 for an off-road vehicle is shown. The differential assembly 10 may include a differential housing 12, a differential cover 14, and a skid shield 16 connected to the differential cover 14.

The differential housing 12 includes an input shaft flange 18 that receives an input shaft (not shown), a first axle shaft flange 20 that receives a first axle shaft 22 and a second axle shaft flange 24 that receives a second axle shaft 26. The differential housing 12 may further include an open end 28. The open end 28 may include a first mounting flange 30 having a plurality of bolt holes corresponding to a plurality of mounting bolts 32. The differential cover 14 defines a bowl shaped body 14A and includes a corresponding second mounting flange 34 adapted to be connected to the first mounting flange 20 and having a plurality of attachment holes 36. The plurality of bolts 32 may be inserted into the corresponding attachment holes 36 in the second mounting flange 34 for securing the differential cover 14 to the mounting flange 34 of the differential housing 12.

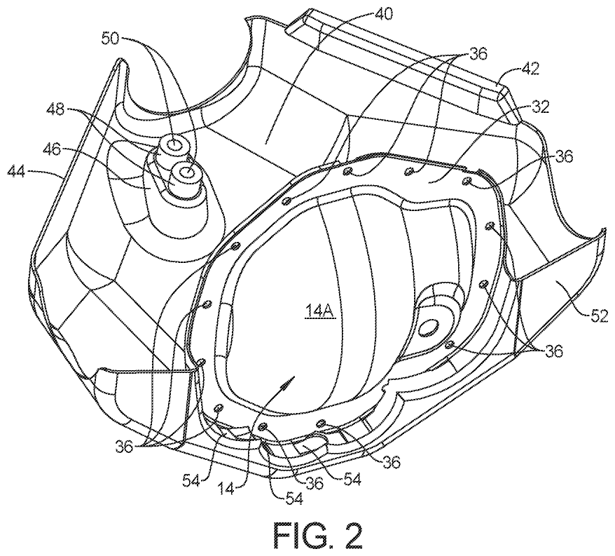

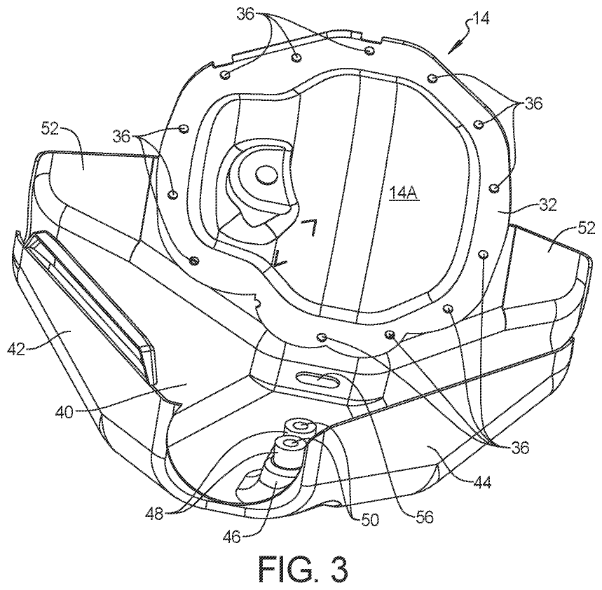

With reference to FIGS. 2-3, the skid shield 16 is shown integrally formed with the differential cover 14 from a single sheet metal. The skid shield 16 extends from the second mounting flange 34 of the differential cover 14. As another example, the skid shield 16 may be welded to the differential cover 14. The skid shield 16 is configured to extend adjacent to a bottom surface of the differential housing 12.

The skid shield cover 16 may include a bottom panel 40 extending longitudinally from the differential cover 14 to the input shaft flange 18, and extending laterally from the first axle shaft flange 20 to a second axle shaft flange 24.

The skid shield cover 16 may further include a first sidewall panel 42 extending from the input shaft flange 18 to the second axle shaft flange 24. The skid shield cover may also include a second sidewall panel 44 extending from the input shaft flange 18 to the first axle flange 20.

The skid shield cover 16 may include a mounting boss 46 extending from the skid shield 14. One or more mounting boss attachment flanges 48 may extend from the mounting boss 46. The mounting boss attachment flanges 48 may define a plurality of mounting boss attachment holes 50 for connecting the bottom panel 40 of the skid shield cover 16 to the bottom of the differential housing 12.

Referring to FIG. 3, the skid shield cover 10 includes a rear panel 52 that extends from a lower perimeter of the second mounting flange 34 to the bottom panel 40. The bottom panel 40 and/or the rear panel 52 may define one or more drain holes 56. Referring to FIG. 2, the skid shield cover 10 may define one or more air outlets 54 defined by the skid shield cover 10. For example, in one embodiment the one or more air outlets 54 may be defined in the skid shield 14 in a location proximal to the differential cover 12. The air holes allow air that enters between the skid shield cover 14 and the differential hosing 12 along the sidewall panels 42, 44 to exit from the skid shield 14 to allow for cooling of the differential housing 12.

The skid shield cover 10 can be made from sheet steel and is designed to crush or flex to absorb any loads prior to slip of the fastened connection to the differential.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A skid shield cover for a differential housing comprising:
a differential cover having a mounting flange extending around a perimeter thereof; and
a skid shield fixedly connected directly to the differential cover,
wherein the skid shield is configured to extend adjacent to a bottom of the differential housing.

2. The skid shield cover of claim 1, further comprising a mounting boss extending from the skid shield.

3. The skid shield cover of claim 1, wherein the skid shield includes a debris exit hole.

4. The skid shield cover of claim 1, wherein the skid shield is configured to define a plurality of air inlets between the skid shield and the differential and the skid shield includes a plurality of air outlets.

5. The skid shield cover of claim 1, further comprising a plurality of mounting holes in the mounting flange of the differential cover.

6. The skid shield cover of claim 1, wherein the differential cover incudes a bowl shaped body extending from the mounting flange.

7. The skid shield cover of claim 1, wherein the skid shield comprises:
a bottom panel configured to extend from the differential cover to an input shaft flange, and configured to extend from a first axle flange to a second axle flange;
a first sidewall panel extending from the bottom panel and configured to extend from the input shaft flange to the first axle flange; and
a second sidewall panel extending from the bottom panel and configured to extend from the input shaft flange to the second axle flange.

8. The skid shield cover of claim 1, wherein the skid shield is formed integral with the differential cover.

9. The skid shield cover of claim 1, wherein the skid shield is welded to the differential cover.

10. A differential assembly comprising:
a differential housing having an input shaft flange, a first axle flange and a second axle flange, and an open end with a first mounting flange having a plurality of attachment holes;
a first axle extends through the first axle flange;
a second axle extends through the second axle flange;
a differential cover includes a second mounting flange connected to the first mounting flange of the differential housing;
a skid shield is connected to the differential cover and extends adjacent to a bottom surface of the differential housing; and
a plurality of bolts inserted into corresponding attachment holes in the first mounting flange and the second mounting flange.

11. The differential assembly of claim 10, wherein the skid shield includes a mounting boss having at least one attachment hole for attachment to the differential housing.

12. The differential assembly of claim 10, further comprising:
an air inlet defined between the skid shield and the differential housing; and
a plurality of air outlets defined by the skid shield.

13. The differential assembly of claim 10, wherein the skid shield includes a drain hole.

14. The differential assembly of claim 10, wherein the skid shield is formed integral with the differential cover.

15. The differential assembly of claim 10, wherein the skid shield is welded to the differential cover.

16. The differential assembly of claim 10, wherein the skid shield is made from sheet metal that is configured to crush or flex in response to an impact in order to prevent slip of the differential cover relative to the differential housing.

17. The differential assembly of claim 10, wherein the differential cover includes a bowl shaped body extending inward from the second mounting flange.

18. A method of attaching a skid shield to a differential housing comprising:
integrally forming a differential cover and a skid shield for a single sheet of metal;
mounting the differential cover to an open end of a differential housing with the skid shield extending along a bottom surface of the differential housing.

19. The method according to claim 18, wherein the differential cover includes a bowl shaped body with a mounting flange extending from the bowl shaped body.

20. The method according to claim 19, wherein the skid shield extends from the mounting flange.
